(19) United States
(12) Patent Application Publication
(10) Pub. No.: US 2016/0253901 A1
(43) Pub. Date: Sep. 1, 2016

(54) METHOD FOR ASSIGNING A TRAVEL LINE TO A VEHICLE AND METHOD FOR CONTROLLING A TRAFFIC SYSTEM

(71) Applicant: SIEMENS AKTIENGESELLSCHAFT, MUENCHEN (DE)

(72) Inventor: GERD ROTHER, MUENCHEN (DE)

(21) Appl. No.: 15/055,803

(22) Filed: Feb. 29, 2016

(30) Foreign Application Priority Data
Feb. 27, 2015 (DE) 102015203505.0

(51) Int. Cl. G08G 1/01

(52) U.S. Cl. CPC G08G 1/0125

(57) ABSTRACT

A method for assigning a travel line to a vehicle, wherein at least one travel line is provided with at least two notification points. The two notification points represent a departure stop with a departure time and an end stop. A local position of the vehicle is detected, and a check is made as to the start time at which the vehicle departed from a particular stop. Based on the detected start time and the detected departure stop, a check is made as to which travel line is assigned to the vehicle.

### CROSS-REFERENCE TO RELATED APPLICATION

This application claims the priority, under 35 U.S.C. §119, of German patent application DE 10 201 5 203 505.0, filed Feb. 27, 2015; the prior application is herewith incorporated by reference in its entirety.

### BACKGROUND OF THE INVENTION

### Field of the Invention

The invention relates to a method for assigning a travel line to a vehicle, to a method for controlling a traffic system, to a processing unit for controlling a traffic system, and to a traffic system.

A dynamic global positioning and notification system for use in local public transport is known from German published patent application DE 198 03 254 A1. The so-called Dynamo system is designed for use in inner-city, regional and trans-regional public transport systems and is built into the vehicles which operate the public transport system. The Dynamo system automatically and continuously detects location coordinates of the vehicle with a navigation unit while the vehicle is on the move and while the vehicle is stationary. A location recognition module compares these coordinates with notification point coordinates stored internally and detects whether the vehicle is located at a notification point. If it is then the vehicle has reached a position at which an action is to take place. An action is for example the transmission of a defined dataset to an LSA (traffic signal system) intersection processor. If an action is to be carried out, the data of which the dataset consists is recognized on the basis of notification parameters stored for each notification point and via which interface the notification data is to be transmitted: via radio, serially or via another interface. The data telegram is then generated and subsequently the data is transmitted.

A method for identifying a subset of positions is known from published patent application US 2010/0144375 A1 and its counterpart German published patent application DE 10 2007 014 528 A1. This enables a local itinerary of journeys taken by a user in different means of public transport to be established. On the basis of this established itinerary the costs of the journeys can then be correctly distributed to the individual operators of the means of transport. A comparison of the coordinates of stops of the means of public transport with the coordinates of base stations for transmit and receive operation in mobile radio forms the basis of the method. These coordinates only have to be established once and can be stored in a memory. If the coordinates of a base station, at which a cell phone is logged in, lie close to the coordinates of this stop, then it is assumed that the owner of this cell phone is at this stop. During the user of the public transport system's journey the base station at which the cell phone is logged in is established at regular intervals—for example at intervals of 30 seconds. The stop that is the shortest distance from the currently activated base station is then established again and the line being traveled by the user is deduced.

A method for determining the route travelled is known from European published patent application EP 1 972 894 A1. In that method, to determine the route travelled by an object under examination on a predetermined route network on which at least one reference object is moving, the route covered is determined, wherein spatial-temporal positioning information of the object under examination is determined, in that a number of spatial check positionings of the object under examination are carried out at temporal intervals and wherein at least one route section is determined on which the object under examination and one of the reference objects moving on the route network are moving and/or have moved in a spatially and temporally matching manner, in that positioning information is compared with spatial-temporal movement information of reference objects which are moving and/or have moved on the route network.

### SUMMARY OF THE INVENTION

It is accordingly an object of the invention to provide a method of assigning a travel line to a vehicle and a method for controlling a traffic system which overcome a variety of disadvantages associated with the heretofore-known devices and methods of this general type and which provides an improved method for assigning a travel line to a vehicle and an improved method for controlling a traffic system.

With the foregoing and other objects in view there is provided, in accordance with the invention, a method for assigning at least one travel line to a vehicle, the method comprising:

providing for at least one travel line, the travel line having at least two notification points representing a departure stop with a departure time and an end stop;

detecting a local position of the vehicle;

checking as to a start time at which the vehicle departs from which departure stop; and

determining, on a basis of the detected start time and the detected departure stop, which of the at least one travel lines is assigned to the vehicle.

One advantage of the method described lies in the fact that at least one travel line is assigned to a vehicle in a simple manner. A further advantage of the method described lies in the fact that enhanced control of a traffic system is achieved in a simple manner.

These advantages are achieved by a vehicle being assigned a travel line as a function of the departure stop and a departure time. In this way the travel line of the vehicle can be detected easily and automatically. Thus a change in a travel line can be established without further effort.

A development of the method is achieved by a further notification point in addition to the departure stop being taken into account in order to assign a travel line to the vehicle. This enables a safe and rapid selection of the travel lines to be achieved.

In one form of embodiment, to select the travel line, an additional notification point and an arrival time at the additional notification point is detected and is taken into account for the choice of travel line. In this way a further improvement for rapid assignment of a travel line to a vehicle is achieved.

In one form of embodiment the travel line is recognized at the latest when the vehicle has left a predetermined departure stop at a predetermined starting time and the journey of the vehicle ends at a defined end stop. This enables an assignment of the vehicle to a defined travel line to be made. A travel line can be defined by a specified departure stop, a specified start time and a specified end stop.

In one form of embodiment a travel circulation with at least two travel lines can be detected. To do this a check is made as to whether the vehicle has travelled over at least two travel lines at least a specified number of times in the same order. Through the automatic detection of a travel circulation the travel circulation of a vehicle can be detected and updated during operation without any great effort.

In one form of embodiment the current travel line and a previous travel line are assigned to the vehicle. In this way a switch over time between the travel lines can be established and especially a travel circulation with a number of travel lines following on from one another in a defined way can be established.

In one form of embodiment it is monitored whether the vehicle is departing from the assigned travel line. In this way adherence to the travel lines by the driver can be monitored.

If the vehicle departs from the predetermined travel line, then the vehicle is assigned an identifier for an unknown journey.

In one form of embodiment a check is made for the vehicle, after detection of deviation from the assigned travel line, as to whether the vehicle is returning to the previous travel line. If it is, the previous travel line is assigned to the vehicle again. If it is not, the unknown journey remains assigned to the vehicle as the current travel line.

In one embodiment the assignment of the travel line to the vehicle is used to control a traffic system for the vehicle. In this way a prioritization of the vehicle in accordance with the assigned travel line can be carried out. Through this an improved system for traffic management is provided.

Other features which are considered as characteristic for the invention are set forth in the appended claims.

Although the invention is illustrated and described herein as embodied in a method for assigning a travel line to a vehicle and method for controlling a traffic system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 shows a schematic diagram of a traffic system; and

FIG. 2 shows a schematic diagram of a travel plan with two travel lines.

### DETAILED DESCRIPTION OF THE INVENTION

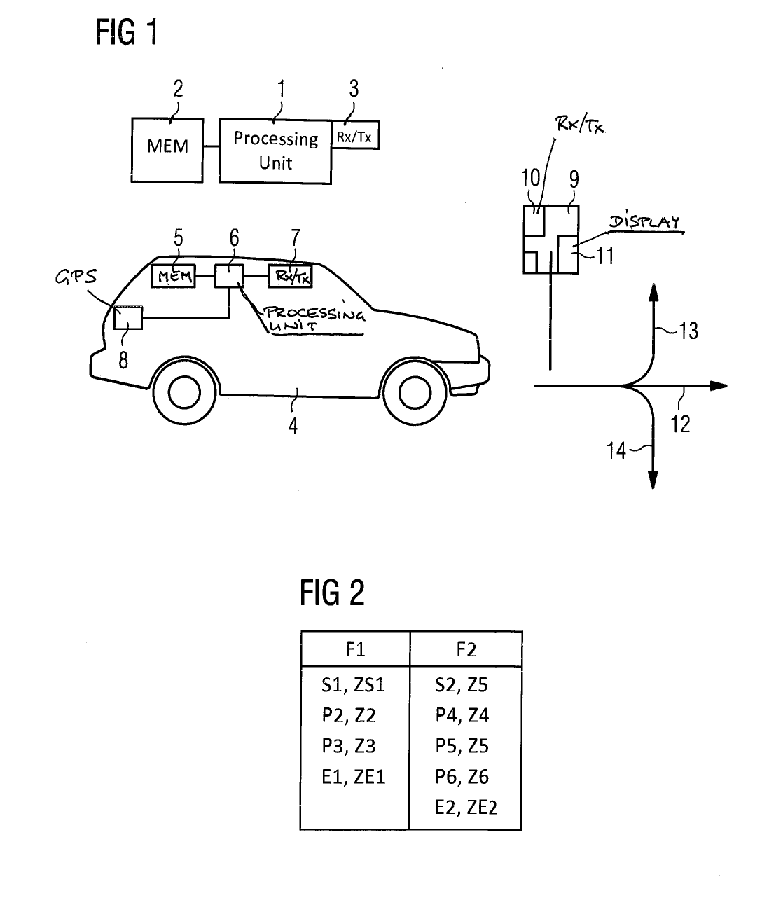

Referring now to the figures of the drawing in detail and first, particularly, to FIG. 1 thereof, there is shown, in a schematic diagram, a processing unit 1, which is connected to a memory 2. In addition the processing unit 1 has a transmit and receive unit 3. There is also shown a vehicle 4, which has a second memory 5 and a second processing unit 6. In addition the vehicle 4 has a second transmit and receive unit 7.

Depending on the form of embodiment selected, the vehicle 4 can also have a GPS system 8 for determining its global position. In addition the position of the vehicle can be detected with the aid of sensors or a camera, which are disposed for example on the traffic lights or at notification points. In addition FIG. 1 shows a traffic control system in the form of a set of traffic lights 9. The traffic lights 9, in the exemplary embodiment shown, have a third transceiver unit 10, a display 11 for displaying an enabled or blocked direction of travel. The display 11, by way of example, can enable or block a direction of travel straight on 12, turning to the left 13 or turning to the right 14. The directions of travel are shown schematically in the form of arrows 12, 13, 14.

FIG. 2 shows, in a schematic diagram, a table for a travel plan of first travel line F1 and a table for a travel plan of a second travel line F2. The first travel line F1 has a first departure stop S1, at which a vehicle is to depart at a first starting time ZS1. In addition further notification points and arrival times are specified for the notification points. The first departure stop S1 is followed by a first notification point P2, which should have been arrived at at a first arrival time Z2. The arrival time can determine the time of arrival at the notification point or the time of departure from the notification point. The first notification point P2 is followed by a second notification point P3, which should have been arrived at at a second arrival time Z3. In addition the first travel line has an end stop E1, which should have been arrived at at an end time ZE1.

The second travel line F2 has a second departure stop S2, from which the vehicle should have departed at a start time ZS2. In addition the second travel line F2 has a fourth notification point P4, which should have been arrived at at a fourth arrival time Z4. The fourth notification point P4 is followed by a fifth notification point P5, which should have been arrived at by the vehicle at a fifth arrival time Z5. This is followed by a sixth notification point P6, which should have been arrived at at a sixth arrival time Z6. In addition the second travel line F2 has an end stop E2, which should have been arrived at at a second end time ZE2.

A departure stop and an end stop likewise represent a notification point. The notification points of the travel lines are travelled through from top to bottom in the corresponding order.

An assignment of a vehicle, especially of a vehicle in a public transport system, to a travel line, can change dynamically during operation. This change can either be undertaken from an online interface by an operator of a fleet of vehicles or can be established automatically via an internal algorithm. A manual assignment of a travel line to a vehicle can be sensible when a travel line is able to be assigned statically to a vehicle.

In principle, when a travel line is assigned automatically to a vehicle, it can be assumed that the travel line is able to be established from the course of a vehicle's journey. Since however, where possible at the start of a journey, the assignment of the travel line to the vehicle should have been known, depending on the selected embodiment, the travel lines (i.e., the courses of the journey for the individual travel lines) are stored beforehand. A travel line contains at least two notification points. In the simplest case these can be a departure stop and an end stop. As a rule travel lines contain more than two notification points, since further notification points or stops are provided between the departure stop and the end stop. Depending on the form of embodiment selected, the method for assigning a travel line to a vehicle can be carried out in a processing unit, especially in a central processing unit.

Depending on the form of embodiment selected, the travel lines can also be established automatically by the vehicle's departure from notification points. In addition departure times for the notification points, especially for the departure stop, are also established automatically. In such cases, depending on a type of day or a date, different departure times can be detected or provided. On different days, especially on working days or Sundays, different travel plans can be provided for a travel line.

A sequence of notification points is understood as a number of notification points from which a vehicle departs. The notification points can represent stops or other geographical points that are defined. A travel line contains a defined sequence of notification points, i.e. a defined sequence of consecutive notification points from which the vehicle departs in turn. If a vehicle switches between two travel lines, the relevant stop between the two travel lines is to be designated as both the end stop and the start stop.

A journey is to be understood as a movement of the vehicle from a departure stop to an end stop. A journey is not absolutely linked to circulations. A journey is identified by a travel line and its line number. This means that a defined number of notification points is predetermined for a journey.

In addition a journey can be defined by a departure time at the departure stop. At the departure stop, at the beginning of a journey of a vehicle, an attempt is made to establish the valid travel line for the journey of the vehicle. This is done for example on the basis of a comparison between the current departure time of the vehicle and planned departure times of different travel lines at the departure stop. If only one travel line that belongs to the departure time detected is found in this check, then this travel line can be assigned to the vehicle immediately. If however there are a number of travel lines available for the same departure time, a further additional check is necessary in order to establish the actual travel line of the vehicle.

The departure time can be understood as a precise departure time or a period of time. For example with busses a departure time is not adhered to precisely as a rule.

At an end stop the journey is ended by the vehicle for example by an identifier being set by the vehicle in which the reaching of the end stop is determined. If a journey of a vehicle begins at a departure stop at a time at which no travel line is provided, then this journey is to be stored after an allowed end stop has been reached and is to be identified as a non-provided journey.

Depending on the selected form of embodiment a vehicle can generally be provided, on leaving a depot, with a predetermined line number, especially given the line number 0. In addition a vehicle can be assigned the predetermined line number 0 if it is recognized that the vehicle has left a previously assigned travel line. In addition a vehicle can be assigned the predetermined line number 0 if, at a departure stop, a number of travel lines begin at approximately the same time and therefore the correct travel line cannot yet be assigned. Furthermore, depending on the form of embodiment selected, a prioritization can also be carried out in relation to other traffic for a vehicle with the line number 0.

This means that for example, after a departure stop with a number of possible travel lines for this point in time of the departure at a signal system, especially at traffic signals of an intersection, even for a vehicle to which no travel line can be uniquely assigned and to which the line number 0 is assigned, a prioritization in relation to other traffic is undertaken. For example a traffic signal can have a proceed signal for the vehicle, especially for a bus or a streetcar which is approaching the traffic signal and has the line number 0. For the line number 0 a defined route is stored as prioritized.

In a further embodiment each vehicle is assigned the parameter current line number, i.e., is assigned the number of a travel line. It can however also be the line number 0, which is used as a placeholder for an undefined travel line. The current line number parameter is used in order to carry out a prioritization of the vehicle in relation to other traffic in the traffic system.

Furthermore, depending on the selected form of embodiment, the previous line number parameter can be stored additionally for a vehicle. The previous line number parameter is derived for example from a current travel line with a current line number. The previous line number can serve as a fallback level, if e.g. because of a diversion, the current travel line, i.e. the current line number, is set to the line number 0, but once the diversion route has been passed, the current travel line is to be employed once again.

Thus the previous line number also serves as an auxiliary variable when there are a number of travel lines with different line numbers available at departure stops at the same departure time. Thus in this situation the previous line number can be retained as the current line number.

Furthermore a last journey line number parameter can be stored for a vehicle. The last journey line number parameter serves as an auxiliary variable for example when a number of travel lines with different line numbers or better with different connecting journeys are possible at departure stops at the same departure time. This parameter, unlike the current line number and the previous line number, is not assigned to a vehicle, especially to the processing unit of a vehicle, but to a travel line, i.e. to a journey. The last journey line number represents a temporal parameter and to a certain extent concatenates consecutive journeys of a vehicle into a travel circulation, without having to introduce this variable in addition. For a concatenation the previous line number parameter is compared with the last journey line number parameter.

Furthermore possible line numbers for travel lines can be assigned to a vehicle when a precise selection of a travel line is not yet possible. With almost identical departure times for a departure stop, for example in a period of between 3 and 5 minutes, for the travel lines in question, the line numbers including the associated parameters are stored temporarily as possible line numbers for the vehicles departing within the period. In the further course of a journey, by the vehicle passing notification points, the choice of possible travel lines can be successively restricted, until a unique and single travel line and its line number is left.

At the subsequent notification points the actions listed below are especially carried out in the sequence described.

Depot Notification Point

For a starting point of a journey, from a depot for example, the following points can be defined for a vehicle by the central processing unit 1: The current travel line is given the line number 0, since the actual travel line is not yet known. The previous travel line is likewise given the line number 0. The possible travel lines are also given the line number 0. In addition a flag for reaching the end stop is set.

Departure Stop Notification Point

A distinction into types of days, i.e. Monday to Friday, Saturday or Sunday can be implemented as a parameter for example. In addition a plan for the travel lines is available for a departure stop, which are different according to type of day for example.

For a travel line, i.e. for a journey, this simultaneously defines a sequence of notification points, which can also be detected automatically. In addition a departure time is defined for each travel line for the departure stop. Depending on the form of embodiment chosen, the departure time can also be detected automatically for a vehicle and subsequently stored as a predetermined departure time. A line number is provided for each travel line. The line numbers can be issued automatically or manually.

In addition a line number is created automatically for the parameter “last journey,” i.e., last travel line, and assigned to the vehicle. Furthermore, depending on the form of embodiment selected, a transition counter can be provided. The transition counter is automatically increased by 1 after ending of a travel line with a successful assignment of the last journey line number parameter at the end stop. With the aid of the transition counter it can be achieved that for example only after an identical transition between two line numbers carried out twice is a fixed travel circulation with the two travel lines determined. The travel circulation then contains these two travel lines. Depending on the form of embodiment selected, a travel circulation can also contain more than two travel lines. The travel circulation known for a vehicle can also be used to prioritize the journey of the vehicle in relation to other traffic.

At the departure stop at least one of the following actions is carried out for example. When the flag “end stop reached” is not set, no action is carried out. This is necessary if the departure stop is only serving temporarily as a departure stop, for example with short turnarounds. Otherwise the following points are carried out: Reset flag “end stop reached”. The current line number of the vehicle is given the line number 0. In addition the current departure time of the vehicle is compared with the predetermined departure times of the various possible travel lines. If a unique assignment of the vehicle to a travel line is possible via the measured departure time and the departure stop, the line number of the unique travel line is assigned to the vehicle as valid line number for the current travel line.

Should a number of lines be involved, the parameters of all travel lines involved are accepted into an area for possible line numbers.

Subsequently a comparison is made between the previous line number and the last journey line number of the travel lines involved. If a travel line is established for which the previous line number and the last journey line number are identical and the associated transition counter is greater than or equal to a predetermined number, especially greater than or equal to 2, the current line number of the vehicle is set equal to the recognized line number from the range of possible travel lines. In addition the previous line number of the vehicle is set to equal the current line number.

If the comparison is not successful or if the transition counter is less than 2, the current line number of the travel line of the vehicle is set to the value 0. The previous line number parameter is retained by the travel line last carried out by the vehicle. In addition the current line number is preferably stored with a time stamp for this travel line.

Depending on the form of embodiment selected, a number of valid travel lines with corresponding line numbers is available for one notification point. If a notification point is passed by a vehicle of which the current line number for the travel line is equal to 0, then a check is made as to whether further possible travel lines are stored for this notification point. If they are, a check is made as to whether one of the possible travel lines could be considered. If it could, a restriction of the travel lines allowed at this notification point is carried out. The other travel lines can be deleted as a function of the form of embodiment selected. Should only one travel line be left during this check, this line will immediately be assigned to the vehicle as the current travel line. The previous travel line parameter is stored under the last journey travel line parameter. Subsequently the previous travel line is set equal to the current travel line.

In a subsequent method point a check is made as to whether the notification point departed from lies on the current travel line of the vehicle. If it does not, the current travel line is given the value 0, i.e. the line number 0. However if the result of the check is that the notification point departed from lies on the travel line, the current travel line is set equal to the previous travel line and a prioritization in the traffic system is enabled. This means that in its further course, the vehicle, in accordance with its assigned travel line, is prioritized in relation to other traffic in relation to a right of way. With the aid of this method, vehicles which are en route on a circulation can again be assigned to the original travel line.

Subsequently for example the current travel line is stored with a time stamp of the notification point and with a specification of the notification point. In addition the flag “end stop reached” is reset.

At the end stop notification point the flag “end stop reached” is set. In addition the current travel line is stored with a time stamp and the specification of the end stop. Subsequently a check is made as to whether the end stop lies on the assigned travel line. If it does not then the travel line for the last journey is set to unknown and the transition counter is set to the value 0.

If the result of the query is that the end stop lies on the assigned travel line, the travel line for the last journey is checked. If the travel line for the last journey is unknown an action is taken. If the travel line for the last journey is stored, the transition counter is increased by the value 1. With the aid of this method for example, after twice successfully travelling over at least two consecutive travel lines, a new travel circulation is automatically recognized and stored.

Different travel plans can be specified for the travel lines for specific locations for different types of day. In this case each notification point or each stop at which a travel line begins is assigned a departure stop. Depending on the form of embodiment selected, at least the travel lines valid at the departure stops are stored for each type of day.

In one embodiment the travel lines can be generated by a vehicle during operation. In this case a travel line is formed from sequences of notification points from which a vehicle departs with the corresponding arrival times. In this case the departure stop is determined for the first notification point and the end stop is determined for the last notification point. The notification points for departure stops and end stops are preferably defined so that they can be positionally well differentiated. With turnaround stops the direction of travel of the vehicle at this stop should additionally be unique. Also the one default line number with the number 0 should be held as allowed as a possible line number at the notification points concerned.

Depending on the form of embodiment selected, each valid notification point with an ID number of the vehicle and a time stamp at which the vehicle arrives at the notification point can be stored. This enables the following evaluations to be performed: Analysis of the course of the vehicle's journey and the quality of the priority over the entire travel line. Analysis of whether new travel lines have been formed. In this case a manual assignment of the line number is necessary. In addition an analysis can be carried out to the effect of whether the departure time is still needed for a departure stop. If this is repeatedly not the case, this departure time can be deleted automatically or manually. Depending on the form of embodiment selected, a parameter can be stored for the period of time that defines the length of time after which the departure time for the departure stop has not been used when it is deleted. This can be one day, two days, three days or a week for example.

Furthermore a cyclical analysis can be carried out to the effect of whether a new departure time has been added to a known travel line. In this case the associated line number of the travel line can be accepted at the new departure time and the travel line can be specified as valid at the new departure time. Thus changes in the travel plan can be detected automatically. Furthermore, for each known travel line an allowed sequence of notification points with the associated notification points can be stored.

Often a number of travel lines can depart from departure stops at the same time or directly after one another. In this situation it is difficult to recognize the correct travel line for the vehicle on the basis of the departure time. Generally two different cases can be used as a starting point:

Case 1: A variable circulation plan is available. This means that there is no fixed assignment between a travel line that ends at the departure stop and the new travel line. This means that is not possible to definitively state which travel line is now the correct new travel line when the vehicle moves away from the departure stop. In this case the travel line should be established by restrictions by means of allowed travel lines at the notification points driven past during the journey. If a unique travel line is established, this is used as the current travel line with the corresponding line number. In order to improve learning about circulations, the as yet unchanged previous travel line parameter is accepted into the last travel line parameter. In this case the established current travel line and the departure time are taken into account. With the aid of this method it is possible to recognized fixed circulations.

Case 2: Fixed circulation plan. With a fixed circulation plan there is a fixed relationship between the previous travel line and the new travel line to be used. In this case there is the ability to learn from the history, in that the transition between the two travel lines is stored and the transition is taken into account in the selection of the new travel line to be determined. The storage of the transitions between the at least two travel lines takes place for example in the last journey travel line parameter. This parameter comprises a departure time from the departure stop and the departure stop. This assignment already taking effect during the first transition between two travel lines should be avoided. This would mean that, even with a variable circulation plan, it can incorrectly be assumed that there is a fixed assignment. An incorrect travel line would thus be recognized as valid. Therefore a transition counter is preferably introduced. Only when the journey has been fully carried out and ends at the planned end stop can the transition counter be incremented. This transition counter is evaluated at the departure stop.

Exemplary sequence: On first arrival after system start at the departure stop, because of a number of possible departure times, a comparison of the previous travel line with the last journey travel line parameter is made. Since the last journey travel line parameter has not yet been determined and is thus identified as invalid, the travel line according to case 1 is determined, as explained above provisionally for all journeys of the vehicle. On next arrival of the vehicle, for example on the next day at the same time of day and the same previous travel line, the comparison according to case 2 is highly likely to be successful. But since the transition counter still has the value 1, in the second pass processing will still be according to case 1. Only if the journey transition was successful twice or frequently in sequence will a fixed circulation plan be recognized.

If a circulation plan is now changed, the following two cases are to be distinguished:

Case 3: A different travel line is started at the same time at the departure stop. In this case an incorrect travel line is assigned. As soon as the distances, i.e. the notification points, differ, this is recognized. As a result thereof the vehicle is assigned the line number 0 for an unknown travel line. At the end stop the route checking is carried out in precisely this way. If the end stop is also incorrect, then a diversion cannot be involved. In this case the last journey travel line parameter is again set to unknown and the transition counter is set to the value 0. Thus a new assignment according to case 1 is possible.

Case 4: The departure time of the connecting journey changes significantly compared to the circulation plan, for example by 10 minutes. If this is the case, then it is of no significance whether the travel line also changes. The new departure time is assigned the last journey travel line parameter in accordance with case 1. The old assignment is retained as unused for the journey that is no longer taking place.

In a further embodiment there is provision that, if a notification point is not passed because of a diversion, this has no effect, since temporal relationships are not checked. If a notification point which does not belong to the assigned travel line is passed during a diversion, this does not lead to any prioritization since the current travel line is set to the line number 0. With each further notification point a check is made for the travel line with the line number 0 whether the previous travel line belongs to the possible travel lines. If it does, this is assigned to the vehicle again as the current travel line. In the simplest case this could also be the travel line with the line number 0.

If load relief journeys take place with the travel line with the line number 0, this travel line is retained for the vehicle, since no possible travel line is available for selection at the notification points. The travel line is stored for the notification point as possible travel line with the line number 0.

Should a vehicle turn around for traffic reasons for example, an invalid intersection sequence is recognized and thus an assignment of the travel line to an unknown travel line, i.e. with the line number 0, is carried out. If during the further journey of the vehicle a unique assignment with the previous travel line is possible, then the previous travel line is accepted again as the current travel line. Otherwise the vehicle of the travel line with the value remains unknown, i.e. is assigned the line number 0.

If there is a timetabled turnaround of the vehicle, then the turnaround stop must be identified both as the end stop and also as the start stop. An assignment of the assigned planned travel lines only takes place at the departure stop notification point if the “end stop reached” flag is set. If a normal journey is taking place, this flag is not set at the departure stop.

At the beginning of the journey the vehicle is normally assigned a line number 0 for an unknown travel line. Vehicles are thus for example only given preference at the intersections parameterized therewith. If a still valid travel line is assigned by mistake, then this is reset because of the unplanned journey course in the vehicle to an unknown travel line and thus to the line number 0. The journey course of a special journey, although evaluated as a possible journey course, since however the departure stop as such is not normally identified, there is no acceptance of the travel line as a new travel line.

The methods described are carried out by the processing unit 1 and/or the second processing unit 6 of the vehicle 4.

The vehicle and/or the central processing unit 1 can have operator interfaces, with which for example day types, notification points for departure stops and end stops and departure times at the departure stops per day type can be defined for example. The day type can distinguish Monday to Friday from a Saturday or a Sunday for example. In addition there can be a visualization of travel lines, especially of sequences of notification points between a start stop and an end stop with an identification of the notification points and of the notification point types. In addition there can be the option, depending on the form of embodiment selected, of manually assigning a line number to travel lines. Furthermore notification point sequences can be detected by journeys undertaken and stored as new travel lines with new line numbers. In addition sequences of notification points can also be entered manually as new travel lines.

Furthermore there can be provision for a visualization of all notification points with the aid of the operator interface, wherein possible travel lines which pass these notification points are formed automatically by an evaluation of the sequences of notification points and assigned line numbers. In addition the departure time and the line number can be shown for each travel line. Furthermore the current travel line, possible travel lines, last journey travel line, the value of the transition counter and the end stop can be visualized. Furthermore there can be a visualization of the travel lines (current or historical) in the form of a list: This list can show a departure stop with the current travel line and a line number. In addition the end stop can be displayed with the current travel line and the line number. Furthermore the last journey travel line can be displayed with the line number. In addition the value of the transition counter can be displayed. Furthermore notification points driven past can be displayed, including the type of notification point with an entry for the time, i.e. the arrival time. Furthermore the current travel line with the line number and the previous travel line with the line number can be displayed. In addition it can be indicated whether the flag “end stop reached” is set or not.

The day type can contain any day of the week, especially a working day, a Saturday, a Sunday, a public holiday or possibly a special day. At the beginning of the day for example the current day type can automatically be derived from the current date. In addition, depending on the form of embodiment selected, a date can be identified manually as a special day. In addition the day types and their XML file format can be received and imported from a traffic computer.

A travel line, i.e. a sequence of notification points, can be detected by the vehicle travelling over a route. The journey of the vehicle can serve to collect data, in order to derive travel lines therefrom. In this case it is sufficient to store the notification points and for example the arrival times at the notification points passed by a vehicle, arranged by a time and to make this data available for a subsequent evaluation or provide it for the definition of travel lines.

A travel line is defined as a sequence of notification points, i.e. a series of a number of notification points. A travel line begins with the departure stop notification point and ends with the end stop notification point. Travel lines can be used in online operation to check whether a vehicle is on a valid journey. Depending on the form of embodiment selected, a travel line can be post-processed, extended or shortened automatically or manually.

Notification points are understood as geographical points to which allowed travel lines are assigned. A notification point can be a departure stop, intermediate point or end stop type of notification point. Depending on the form of embodiment selected each notification point can be automatically or manually assigned the following parameters: Departure time with the attributes day type, time of day, travel line. The current day type can be defined automatically at the beginning of the day.

A journey begins with a fixed defined departure time, preferably related to day type, at a defined departure stop and is assigned to a vehicle. The journey can be used in order to check online whether a vehicle is undertaking a journey started in accordance with a predetermined travel line. Completed journeys, which are defined by reaching the end stop, can be stored for quality observations. In addition the following parameters can be formed automatically for each journey: Vehicle identifier, departure time of the journey at the departure stop, current travel line, last journey travel line and transition counter.

Referring once more to FIG. 1, there is shown a traffic situation in which the vehicle 4 is nearing an intersection at which traffic signals control (closed-loop-control) the traffic. The processing unit 1, which can represent a central processing unit, establishes for the vehicle 4, as a function of the method described above, a travel line or a circulation or a circulation plan, which is being followed by the vehicle. A circulation plan can comprise a number of travel lines, which are followed in a defined order. The vehicle 4 is assigned a corresponding travel line by the processing unit 1. The assignment is transferred from the processing unit 1 to the vehicle 4 via the transmit-receive units 3, 7.

In a further embodiment the second processing unit 6 can also establish for the vehicle 4, depending on the method described above, a travel line or a circulation or a circulation plan, which is being followed by the vehicle 4.

If the vehicle 4 now approaches a signal system of a traffic system, especially a traffic light signal 9, the vehicle 4 transfers the assigned travel line, in the form of a line number for example, to the traffic light signal 9. Subsequently the traffic light signal 9 can carry out a prioritization of the vehicle 4 in accordance with the travel line transferred. To this end corresponding prioritizations are stored in a memory of the traffic light signals in relation to a priority of the corresponding travel lines. For example on arrival of the vehicle 4 a left turn is preferred to going straight ahead, if the travel line of the vehicle provides a left turn to this traffic light signal. Thus a free passage is switched for the vehicle 4 by the traffic light signal with priority over other traffic. Depending on the selected form of embodiment, going straight ahead or turning right can also be prioritized in accordance with the travel line assigned to the vehicle 4. Instead of a traffic light signal other signaling systems or switching systems can also be provided, such as interlockings for tracks for a rail-based vehicle.

Depending on the form of embodiment selected, the travel line assigned to the vehicle 4 can also be transferred directly from the processing unit 1 to the traffic light signal 9 via the transmit-receive units 3, 10. In addition an identification for the vehicle is transferred with the travel line. In this form of embodiment it is sufficient for the vehicle 4 to transfer its identification to the traffic light signal when approaching the traffic light signal 9. The traffic light signal 9 has a processing unit and on the basis of the transfer of the identification, can prioritize a travel line assigned to the identification, i.e. give it preference over other traffic. The vehicle can be a bus, a train, a streetcar or an automobile for example.

Instead of the traffic light signal 9, any other type of signal system, especially a traffic management system, a barrier, a track switch etc., with which a guidance or a control and especially a prioritization of a traffic route or a means of transport is possible.

Although the invention has been illustrated and described in greater detail by the preferred exemplary embodiment, the invention is not restricted by the disclosed examples and other variations can be derived therefrom by the person skilled in the art, without departing from the scope of protection of the invention.

1. A method for assigning at least one travel line to a vehicle, the method comprising:
providing for at least one travel line, the travel line having at least two notification points representing a departure stop with a departure time and an end stop;
detecting a local position of the vehicle;
checking as to a start time at which the vehicle departs from which departure stop; and
determining, on a basis of the detected start time and the detected departure stop, which of the at least one travel lines is assigned to the vehicle.

2. The method according to claim 1, which comprises assigning more than one travel line to the vehicle after the vehicle leaves the departure stop, detecting at least one further notification point at which the vehicle arrives, the notification point being assigned to at least one travel line, and reducing possible travel lines which will be assigned to the vehicle on a basis of the at least one travel line of the at least one further notification point.

3. The method according to claim 2, which comprises assigning an arrival time to a notification point, the arrival time specifying a time at which a vehicle arrives at a notification point on a travel line, detecting an arrival time of the vehicle at the notification point, and comparing the arrival time of the vehicle with the arrival time of the travel line of the notification point, in order to reduce the possible travel lines of the vehicle.

4. The method according to claim 2, which comprises, on the basis of the notification points or on the basis of the notification points and the arrival time of at least one travel line, reducing the possible travel lines until such time as only a single travel line is assigned to the vehicle.

5. The method according to claim 1, which comprises recognizing a travel line if the vehicle leaves the departure stop at a defined starting time and the journey of the vehicle ends at the defined end stop.

6. The method according to claim 5, which comprises assigning the vehicle a current travel line for a current journey and a previous travel line for a previous journey.

7. The method according to claim 1, wherein a circulation comprises at least two defined travel lines, and assigning the circulation to the vehicle if the vehicle has traveled the circulation at least a defined number of times.

8. The method according to claim 1, which comprises assigning the vehicle a current travel line for a current journey and a previous travel line for a previous journey.

9. The method according to claim 1, which comprises, after assignment of a travel line to the vehicle, detecting a journey of the vehicle and, if the vehicle deviates from the assigned travel line, assigning the vehicle an unknown journey as a current travel line.

10. The method according to claim 9, wherein, upon recognizing a deviation from the assigned travel line, effecting a check on the basis of the notification points arrived at as to whether the vehicle has returned to a previous travel line of the vehicle, and, upon a return to the previous travel line, assigning the previous travel line to the vehicle as the current travel line.

11. A method of controlling a traffic system, which comprises:
establishing a travel line for a vehicle by carrying out the method according to claim 1; and
based on the travel line established for the vehicle, prioritizing the vehicle within the traffic system in accordance with the travel line.

12. The method according to claim 11, wherein the vehicle is a public transport vehicle and a traffic control system receives information about the travel line of the vehicle, and wherein the traffic control system, as the vehicle approaches the traffic control system, undertakes a prioritization of the vehicle relative to other traffic in accordance with the travel line, and wherein the traffic control system is a device selected from the group consisting of a signal system, a traffic light and a rail switch.

13. The method according to claim 11, wherein the vehicle is assigned a travel circulation with at least two travel lines, and the prioritizing step comprises undertaking a prioritization of the vehicle in accordance with the travel circulation.

14. The method according to claim 11, wherein the vehicle is a bus, a train, an aircraft, a streetcar or an automobile.

15. A processing unit, configured to carry out the method according to claim 1.

16. A traffic system, configured to carry out the method according to claim 11.
